(19) United States
(12) Patent Application Publication
(10) Pub. No.: US 2023/0311634 A1
(43) Pub. Date: Oct. 5, 2023

(54) DUAL ROTOR MOTOR AND A HYBRID POWERTRAIN USING SAME

(71) Applicants: HYUNDAI MOTOR COMPANY, Seoul (KR); KIA CORPORATION, Seoul (KR)

(72) Inventors: Min Ho Chae, Incheon (KR); Jae Wan Choi, Anyang-si (KR)

(73) Assignees: HYUNDAI MOTOR COMPANY, Seoul (KR); KIA CORPORATION, Seoul (KR)

(21) Appl. No.: 17/949,849

(22) Filed: Sep. 21, 2022

(30) Foreign Application Priority Data
Mar. 30, 2022 (KR) 10-2022-0039507

(51) Int. Cl. B60K 6/26; B60K 11/04; F16H 37/08; B60K 6/547; H02K 16/02; H02K 9/19

(52) U.S. Cl. CPC B60K 6/26; B60K 11/04; F16H 37/0806; B60K 6/547; H02K 16/02; H02K 9/19; B60Y 2200/92

(57) ABSTRACT

The present disclosure comprises a dual-rotor motor having an inner rotor and an outer rotor, a stator disposed between the inner rotor and the outer rotor, a cooling passage provided inside of the stator to block a magnetic path between inside and outside of the stator, and a refrigerant flowing through the cooling passage.

### CROSS REFERENCE TO RELATED APPLICATION

The present application claims priority to Korean Patent Application No. 10-2022-0039507, filed Mar. 30, 2022, the entire contents of which are incorporated herein for all purposes by this reference.

### BACKGROUND

### Field of the Disclosure

The present disclosure relates to a dual-rotor motor and a hybrid powertrain using same.

### Description of the Related Art

The dual-rotor motor is a motor in which rotors are arranged on both sides of inner and outer circumferences of the stator, so that the inner rotor inside the stator and the outer rotor outside the stator may rotate independently of each other.

Therefore, the stator, to independently operate the inner rotor and the outer rotor, is provided with slots in the inner and outer circumference surfaces, respectively. The stator has a structure that each coil is wound by using these slots.

The foregoing is intended merely to aid in the understanding of the background of the present disclosure. The foregoing is not intended to mean that the present disclosure falls within the purview of the related art that is already known to those having ordinary skill in the art.

### SUMMARY

Therefore, the present disclosure has been made in view of the above problems, and it is an object of the present disclosure to provide a dual-rotor motor with improved output torque density and cooling performance.

Another object of the present disclosure is to provide a hybrid powertrain capable of securing excellent mountability in a vehicle with a more compact configuration using the dual-rotor motor.

To accomplish the above object, a dual-rotor motor comprises: an inner rotor and an outer rotor; a stator disposed between the inner rotor and the outer rotor; a cooling passage provided inside of the stator to block a magnetic path between inside and outside of the stator; and a refrigerant flowing through the cooling passage.

The stator is disposed so that inner teeth facing the inner rotor and outer teeth facing the outer rotor are aligned in a radial direction. The cooling passage may include an expansion portion between the inner teeth and the outer teeth to expand the cross-sectional area of the flow passage of the cooling passage.

The cooling passage is configured to connect to a refrigerant pump and a radiator to cool the refrigerant and to circulate the cooling passage by cooling the refrigerant. In other words, the cooling passage is configured to connect to a refrigerant pump and a radiator, where the radiator is configured to cool the refrigerant and the refrigerant pump is configured to circulate the refrigerant cooled by the radiator to the cooling passage.

To accomplish the above object, a hybrid powertrain comprises: a dual-rotor motor having an inner rotor and an outer rotor on the inside and outside of a stator, respectively; and a clutch connecting an engine to any one of the inner rotor or the outer rotor of the dual-rotor motor. The inner rotor and the outer rotor are connected respectively to any one of a first input shaft or a second input shaft of a transmission.

The stator of the dual-rotor motor may include: a cooling passage provided inside of the stator to block a magnetic path between inside and outside of the stator; and a refrigerant to circulate in the cooling passage.

The stator is disposed so that inner teeth facing the inner rotor and outer teeth facing the outer rotor are aligned in a radial direction. The cooling passage may include an expansion portion between the inner teeth and the outer teeth to expand the cross-sectional area of the flow passage of the cooling passage.

The cooling passage is configured to connect to a refrigerant pump and a radiator to cool the refrigerant and to circulate the refrigerant cooled by the radiator to the cooling passage.

At least one drive gear of an odd-numbered shift range is provided on the first input shaft, at least one drive gear of an even-numbered shift range is provided on the second input shaft, and a first output shaft and a second output shaft are provided in parallel to the first input shaft and the second input shaft. The first output shaft and the second output shaft may include a driven gear of an odd-numbered shift range that implement an odd-numbered gear shift range by meshing with the drive gear of an odd-numbered shift range, or include a driven gear of an even-numbered shift range that implement an even-numbered gear shift range by meshing with the drive gear of an even-numbered shift range.

The first output shaft and the second output shaft are provided with a first output gear and a second output gear, respectively. A ring gear of a differential device may be meshed with the first output gear and the second output gear.

The outer rotor is connected to the first input shaft, the first input shaft is connected to the engine through the clutch, and the second input shaft may be connected to the inner rotor and may be formed of a hollow shaft surrounding the first input shaft.

The inner rotor is connected to the first input shaft, the first input shaft is connected to the engine through the clutch, and the second input shaft may be connected to the outer rotor and may be formed of a hollow shaft surrounding the first input shaft.

The present disclosure provides a dual-rotor motor with improved output torque density and improved cooling performance.

In addition, the present disclosure provides a hybrid powertrain capable of securing excellent mountability in a vehicle with a more compact configuration using the above dual-rotor motor.

### BRIEF DESCRIPTION OF THE DRAWINGS

FIG. 1 is a view illustrating an embodiment of a dual-rotor motor according to the present disclosure.

FIG. 2 is a cross-sectional view taken along lines II-II of FIG. 1.

FIG. 3 is a view illustrating an embodiment of a hybrid powertrain according to the present disclosure.

FIG. 4 is a view illustrating a structure in which the dual-rotor motor of FIG. 3 is connected to an engine, a first input shaft, and a second input shaft.

FIG. 5 is a view illustrating another structure in which a dual-rotor motor is connected to an engine, a first input shaft, and a second input shaft.

### DETAILED DESCRIPTION

Regarding embodiments of the present inventive concept disclosed in this specification or application, the specific structural or functional description is merely illustrative for the purpose of describing the embodiments of the disclosure. Embodiments of the disclosure may be implemented in various forms but should not be construed as being limited to the embodiments set forth in this specification or application.

Because the embodiments of the disclosure may be variously modified and have various forms, specific embodiments are illustrated in the drawings and described in detail in this specification or application. However, it should be understood that embodiments of the disclosure are intended not to be limited to the specific embodiments but to cover all modifications, equivalents, or alternatives without departing from the spirit and technical scope of the present disclosure.

Terms such as “first” and “second” may be used to describe various components, but the components are not restricted by the terms. The terms are used only to distinguish one component from another component. For example, a first component may be named a second component without departing from the scope of the present specification. Likewise, a second component may be named a first component.

It should be understood that when a component is referred to as being “connected to” or “coupled to” another component, it may be directly connected to or coupled to another component or intervening components may be present. In contrast, when a component is referred to as being “directly connected to” or “directly coupled to” another component, there are no intervening components present. Other expressions describing relationships between components such as “between”, “immediately between” or “adjacent to” and “directly adjacent to” may be construed similarly.

When a component, device, element, or the like of the present disclosure is described as having a purpose or performing an operation, function, or the like, the component, device, or element should be considered herein as being “configured to” meet that purpose or to perform that operation or function.

The terms used in the present specification are merely used to describe specific embodiments and are not intended to limit the present disclosure. As used herein, the singular form is intended to include the plural forms as well, unless context clearly indicates otherwise. In the present application, it should be further understood that the terms “comprises,” “includes,” and the like specify the presence of stated features, integers, steps, operations, elements, components, or combinations thereof. However, these terms do not preclude the presence or addition of one or more other features, integers, steps, operations, elements, components, or combinations thereof.

Unless defined otherwise, all technical and scientific terms used herein have the same meaning as commonly understood by one of ordinary skill in the art to which this inventive concept belongs. It should be further understood that terms defined in commonly used dictionaries should be interpreted as having a meaning that is consistent with their meaning in the context of the related art and should not be interpreted in an idealized or overly formal sense unless expressly so defined herein.

Hereinafter, embodiments of the present disclosure are described in greater detail with reference to the accompanying drawings. Like numerals refer to like elements throughout.

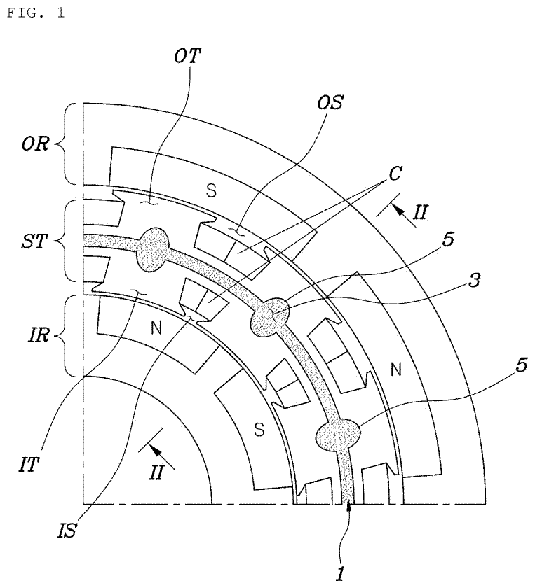

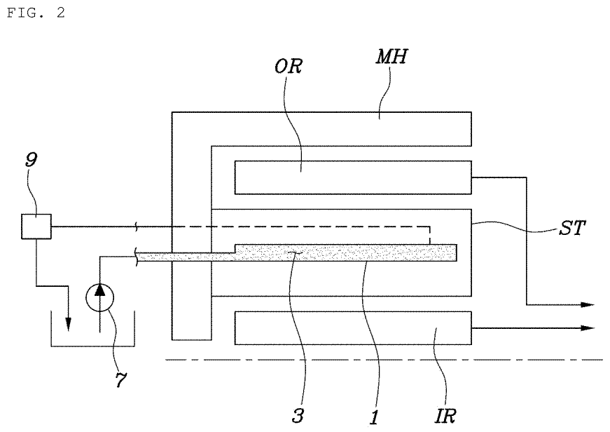

In FIG. 1 and FIG. 2, an embodiment of a dual-rotor motor of the present disclosure comprises: an inner rotor IR and an outer rotor OR; a stator ST disposed between the inner rotor IR and the outer rotor OR; a cooling passage 1 provided inside of the stator ST to block a magnetic path between inside and the outside of the stator ST; and a refrigerant 3 flowing through the cooling passage 1.

In other words, the cooling passage 1 inside of the stator ST and the refrigerant 3 flowing therethrough may block a magnetic path between the inside and the outside of the stator ST, so that a closed magnetic path formed between the stator ST and the outer rotor OR and a closed magnetic path formed between the stator ST and the inner rotor IR are reliably separated independently of each other. Thus, such a configuration may reduce leakage and loss of magnetic flux and may ensure that the independent driving of the inner rotor IR and the outer rotor OR may be implemented more reliably.

In the stator ST, inner teeth IT facing the inner rotor IR and outer teeth OT facing the outer rotor OR are aligned in a radial direction. The cooling passage 1 may include an expansion portion 5 having an expanded passage cross-sectional area between the inner teeth IT and the outer teeth OT.

Accordingly, the effect of more reliably blocking the magnetic path may be achieved between the inner teeth IT and the outer teeth OT where the expansion portion 5 is positioned, so that the closed magnetic path formed outside the stator ST and the closed magnetic path formed inside the stator ST may be separated more reliably.

The refrigerant 3 flowing through the cooling passage 1 comprises cooling water or other non-magnetic materials. By using a material capable of effectively absorbing heat from the stator ST, it is desirable that the heat generated from the dual-rotor motor is cooled effectively.

The cooling passage 1 may be configured to connect to a refrigerant pump 7 and a radiator 9 and circulate the refrigerant 3 cooled by the radiator 7 to the cooling passage 1. In other words, the cooling passage 1 is configured to connect to a refrigerant pump 7 and a radiator 9, where the radiator 9 is configured to cool the refrigerant 3 and the refrigerant pump 7 is configured to circulate the refrigerant 3 cooled by the radiator 9 to the cooling passage 1.

Accordingly, the refrigerant pump 7 pumps the refrigerant 3 cooled by the radiator 9 to the stator ST. As the refrigerant 3 supplied from the refrigerant pump 7 circulates in the stator ST, the heat generated may be effectively cooled. In addition, the refrigerant 3 circulating in the stator ST reliably separates the magnetic path inside and outside the stator ST.

For reference, in FIG. 1, an inner slot IS is formed between the inner teeth IT, an outer slot OS is formed between the outer teeth OT, and in the inner slot IS and the outer slot OS, a coil C wound around the inner teeth IT and the outer teeth OT, respectively, is positioned.

In FIG. 2, the stator ST is fixed to a motor housing MH, and the dotted line inside the stator ST simply illustrates the cooling passage 1 through which the refrigerant 3 flows out.

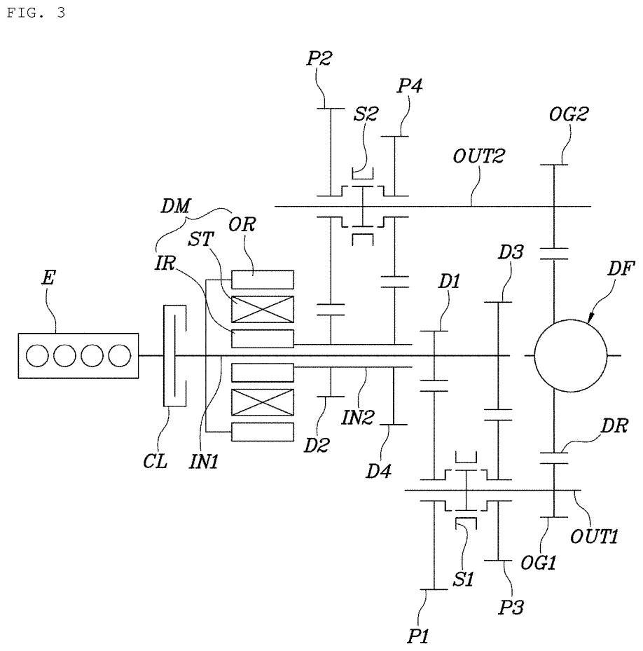

FIG. 3 is a view illustrating an embodiment of a hybrid powertrain according to the present disclosure. The hybrid power train includes: a dual-rotor motor DM provided with the inner rotor IR and the outer rotor OR on the inside and the outside of the stator ST; and a clutch CL connecting any one of the inner rotor IR or the outer rotor OR of the dual-rotor motor DM to an engine E.

In the present embodiment, the outer rotor OR and the inner rotor IR are connected to a first input shaft IN1 and a second input shaft IN2 of a transmission, respectively.

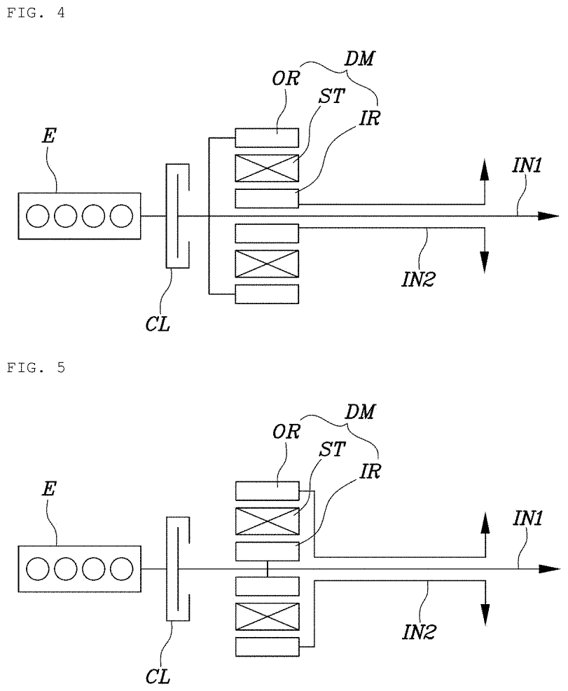

In other words, as shown in FIG. 4, the outer rotor OR is connected to the first input shaft IN1 of the transmission and the first input shaft IN1 is connected to the engine E through the clutch CL. The inner rotor IR is connected to the second input shaft IN2 of the transmission. The second input shaft IN2 is a hollow shaft surrounding the first input shaft IN1 and is configured to be concentrically arranged with the first input shaft IN1.

The stator ST of the dual-rotor motor DM is provided with a cooling passage 1 in the stator ST so as to block the magnetic path between the outside and the inside of the stator ST. The cooling passage 1 is configured such that the refrigerant 3 flows therethrough.

In the stator ST, inner teeth IT facing the inner rotor IR and outer teeth OT facing the outer rotor OR are aligned in a radial direction. The cooling passage 1 may include an expansion portion 5 having an expanded passage cross-sectional area between the inner teeth IT and the outer teeth OT.

The cooling passage 1 is connected to the cooling pump 7 and the radiator 9 to cool the refrigerant 3 that is configured to circulate to the cooling passage 1.

The first input shaft IN1 is provided with at least one of the drive gears of an odd-numbered shift range. The second input shaft IN2 is provided with at least one of the drive gear of an even-numbered shift range. A first output shaft OUT1 and a second output shaft OUT2 that are parallel to the first input shaft IN1 and the second input shaft IN2 are provided. The first output shaft OUT1 and the second output shaft OUT2 include a driven gear of an odd-numbered shift range that implements an odd-numbered gear shift range by meshing with the drive gear of an odd-numbered shift range. Alternatively, the first output shaft OUT1 and the second output shaft OUT2 include a driven gear of an even-numbered shift range that implements an even-numbered gear shift range by meshing with the drive gear of an even-numbered shift range.

In other words, in an embodiment of FIG. 3, a first-stage drive gear D1 and a third-stage drive gear D3 are installed on the first shaft input IN1. A second-stage drive gear D2 and a fourth-stage drive gear D4 are installed on the second input shaft IN2. A first-stage driven gear P1 and a third-stage driven gear P3 are installed on the first output shaft OUT1. A second-stage driven gear P2 and a fourth-stage driven gear P4 are installed on the second output shaft OUT2.

A first synchronizing unit S1 is installed between the first-stage driven gear P1 and the third-stage driven gear P3, and a second synchronizing unit S2 is installed between the second-stage driven gear P2 and the fourth-stage driven gear P4, so that the first synchronizing unit S1 is selectively implemented to as either first-stage or third-stage, and the second synchronizing unit S2 is selectively implemented to as either second-stage or fourth-stage.

A first output gear OG1 and a second output gear OG2 are installed on the first output shaft OUT1 and the second output shaft OUT2, respectively, and a ring gear DR of a differential device DF is meshed with the first output gear OG1 and the second output gear OG2.

Accordingly, the power shifted through the first input shaft IN1 and the first output shaft OUT1 and the power shifted through the second input shaft IN2 and the second output shaft OUT2 are output to the driving wheels through the differential device DF.

The hybrid powertrain as described above may implement an electric vehicle mode, a series mode, and a parallel mode.

In the electric vehicle mode, in a state in which the clutch CL is released, an odd-numbered shift range may be implemented by driving the outer rotor OR, and an even-numbered shift range may be implemented by driving the inner rotor IR.

In the series mode, electric power is generated by driving the outer rotor OR with the power from the engine E by connecting the clutch CL, and driving the inner rotor IR with the corresponding electric power is operated and implemented.

In the parallel mode, the outer rotor OR is driven in a state in which the clutch CL is connected. Therefore, it is implemented so that the power of the engine E and the power provided by the outer rotor OR are supplied to the first input shaft IN1 together.

Unlike FIGS. 3 and 4, the dual-rotor motor DM may have a connecting relationship as shown in FIG. 5.

In other words, the inner rotor IR is connected to the first input shaft IN1. The first input shaft IN1 is connected to the engine E through the clutch CL. The second input shaft IN2 is connected to the outer rotor OR. The first input shaft IN1 is a hollow shaft surrounding the first input shaft IN1.

Although the embodiments of the present disclosure have been disclosed for illustrative purposes, those having ordinary skill in the art should appreciate that various modifications, additions, and substitutions are possible, without departing from the scope and spirit of the disclosure as disclosed in the accompanying claims.

What is claimed is:

1. A dual-rotor motor comprising:
an inner rotor and an outer rotor;
a stator disposed between the inner rotor and the outer rotor;
a cooling passage provided inside of the stator to block a magnetic path between inside and outside of the stator; and
a refrigerant flowing through the cooling passage.

2. The dual-rotor motor of claim 1, wherein the stator is disposed so that inner teeth facing the inner rotor and outer teeth facing the outer rotor are aligned in a radial direction, and the cooling passage is provided with an expansion portion between the inner teeth and the outer teeth to expand a cross-sectional area of the cooling passage.

3. The dual-rotor motor of claim 1, wherein the cooling passage is configured to connect to a refrigerant pump and a radiator to cool the refrigerant and to circulate the refrigerant cooled by the radiator to the cooling passage.

4. A hybrid powertrain comprising:
a dual-rotor motor having an inner rotor and an outer rotor on the inside and outside of a stator, respectively; and
a clutch connecting an engine to any one of the inner rotor or the outer rotor of the dual-rotor motor,
wherein the inner rotor and the outer rotor are connected respectively to any one of a first input shaft or a second input shaft of a transmission.

5. The hybrid powertrain of claim 4, wherein the stator of the dual-rotor motor comprises:
a cooling passage provided inside of the stator to block a magnetic path between inside and outside of the stator; and
a refrigerant to circulate in the cooling passage.

6. The hybrid powertrain of claim 5, wherein the stator is disposed so that inner teeth facing the inner rotor and outer teeth facing the outer rotor are aligned in a radial direction, and the cooling passage includes an expansion portion between the inner teeth and the outer teeth to expand a cross-sectional area of the cooling passage.

7. The hybrid powertrain of claim 5, wherein the cooling passage is configured to connect to a refrigerant pump and a radiator to cool the refrigerant and to circulate the refrigerant cooled by the radiator to the cooling passage.

8. The hybrid powertrain of claim 4, comprising:
at least one drive gear of an odd-numbered shift range provided on the first input shaft;
at least one drive gear of an even-numbered shift range provided on the second input shaft; and
a first output shaft and a second output shaft provided in parallel to the first input shaft and the second input shaft,
wherein the first output shaft and the second output shaft include a driven gear of an odd-numbered shift range that implements an odd-numbered gear shift range by meshing with the at least one drive gear of the odd-numbered shift range, or include a driven gear of an even-numbered shift range that implements an even-numbered gear shift range by meshing with the at least one drive gear of the even-numbered shift range.

9. The hybrid powertrain of claim 8, wherein the first output shaft and the second output shaft are provided with a first output gear and a second output gear, respectively, and a ring gear of a differential device is meshed with the first output gear and the second output gear.

10. The hybrid powertrain of claim 4, wherein the outer rotor is connected to the first input shaft, the first input shaft is connected to the engine through the clutch, and the second input shaft is connected to the inner rotor and is formed of a hollow shaft surrounding the first input shaft.

11. The hybrid powertrain of claim 4, wherein the inner rotor is connected to the first input shaft, the first input shaft is connected to the engine through the clutch, and the second input shaft is connected to the outer rotor and is formed of a hollow shaft surrounding the first input shaft.
